(19) United States
(12) Patent Application Publication
(10) Pub. No.: US 2022/0394035 A1
(43) Pub. Date: Dec. 8, 2022

(54) DATA CLUTCH FOR UNMATCHED NETWORK RESOURCES

(71) Applicant: Forgence, Inc., Austin, TX (US)

(72) Inventor: John Schieferle Uhlenbrock, Austin, TX (US)

(21) Appl. No.: 17/805,811

(22) Filed: Jun. 7, 2022

Related U.S. Application Data
(60) Provisional application No. 63/197,860, filed on Jun. 7, 2021.

(51) Int. Cl. H04L 9/40

(52) U.S. Cl. CPC H04L 63/10; H04L 63/1441

(57) ABSTRACT

A method includes at a first electronic device, receiving at a browser, a first request for data, wherein the first request includes a first identifier of a location of the data on a network, passing the first request from the browser to a gateway, performing, by the gateway, a comparison of the first identifier against items of a first list and items of a second list. When the identifier is not an item of the first list or an item of the second list, initiating, by the gateway, a data clutch including sending from the gateway to a trusted device, a request for manual authorization to be displayed by the browser, receiving, from the trusted device, manual authorization, passing, an approval request to an authorization layer, and receiving, by the browser, an approval from the authorization layer in response to the approval request, and obtaining the requested data.

### CROSS REFERENCE TO RELATED APPLICATION AND CLAIM OF PRIORITY

This application claims priority under 35 U.S.C. § 119(e) to U.S. Provisional Patent Application No. 63/197,860 filed on Jun. 7, 2021. The above-identified provisional patent application is hereby incorporated by reference in its entirety.

### TECHNICAL FIELD

This disclosure relates generally to network security and mitigating the risk of malicious interaction between machines of a secure network and unknown actors on an outside network. More specifically, the present disclosure is directed to systems and methods for implementing a data clutch for actuating interactions between machines of a secure network and unfamiliar resources of an outside network.

### BACKGROUND

The risks associated with receiving data and communications from unvetted or unfamiliar resources of an outside network (for example, the internet) include, without limitation, insertion of malware onto an internal network, phishing attacks, and parasitic overconsumption of network resources through unwanted network traffic with a malicious actor on an outside network (for example, DDOS attacks) are well known and present a serious and persistent technical challenge in the field of network security.

Historically, hardening internal networks against the well-recognized threats from actors associated with unfamiliar web addresses has required compromises across one or more dimensions of network or device performance. As one example, filtering and web security applications can be installed on the individual machines of the network. However, the security gains of this approach typically come at the cost of performance on the individual machines (which are running an additional application), and increased administrative challenges associated with ensuring that updates to the security application are pushed out to individual machine of the network. Another approach is to implement and maintain lists of allowed and/or blocked network locations (previously referred to as “whitelists” and “blacklists”). While this approach can effect some security gains, these gains likewise come, at a minimum, at the administrative costs of having to diligently and continuously updated the gating lists to keep pace with the discovery of network locations of interest. Further, this approach also leaves open the issue of what to do with network addresses that have neither been confirmed as safe (i.e., members of an “allowed list”) nor confirmed as malicious (i.e., as members of a “blocked list.”).

Accordingly, hardening internal networks against the risks associated with interactions with unmatched (i.e., not having been matched to an “allowed” or “blocked” category) network resources without imposing unwanted performance costs, such as in terms of processing overhead, or increased management burden for network administrators, presents a source of technical challenges and opportunities for improvements in the art.

### SUMMARY

This disclosure provides to systems and methods for implementing a data clutch for actuating interactions between machines of a secure network and unfamiliar resources of an outside network.

In a first embodiment, a method includes, at a first electronic device having a processor and connected to a network, receiving at a browser, a first request for access to a network resource, wherein the first request includes a first identifier of a location on the network. The method further includes passing the first request from the browser to a gateway, performing, by the gateway, a comparison of the first identifier against items of a first list and items of a second list, responsive to determining, based on the comparison, that the first identifier is not an item of the first list or an item of the second list, initiating, by the gateway, a data clutch process. The data clutch process includes sending from the gateway to a trusted device, a request for manual authorization, receiving manual authorization at the trusted device, responsive to notification of the manual authorization, passing an approval request to an authorization layer, and receiving, by the browser, an approval from the authorization layer in response to the approval request. The method further includes responsive to receiving the approval from the authorization layer, accessing the requested network resource.

In a second embodiment, an apparatus includes a network interface connected to a network, a processor and a memory containing instructions. When the instructions are executed by the processor, they cause the apparatus to receive at a browser executing on the apparatus, a first request for access to a network resource, wherein the first request includes a first identifier of a location on the network, pass the first request from the browser to a gateway for comparison of the first identifier against items of a first list and items of a second list, responsive to a determination by the gateway that the identifier is not an item of the first list or an item of the second list, receive, from the gateway, a request for manual authorization to be displayed by the browser, obtain notification of manual authorization at a trusted device, responsive to receiving notification of the manual authorization, pass an approval request to an authorization layer, receive, by the browser, an approval from the authorization layer in response to the approval request, and responsive to receiving the approval from the authorization layer, access the requested network resource.

In a third embodiment, a non-transitory computer program product includes program code, which, when executed by a processor, causes an apparatus to receive at a browser executing on the apparatus, a first request for access to a network resource, wherein the first request includes a first identifier of a location on the network, pass the first request from the browser to a gateway for comparison of the first identifier against items of a first list and items of a second list, responsive to a determination by the gateway that the identifier is not an item of the first list or an item of the second list, receive, from the gateway, a request for manual authorization to be displayed by the browser, obtain notification of manual authorization at a trusted device, responsive to receiving notification of the manual authorization, pass an approval request to an authorization layer, receive, by the browser, an approval from the authorization layer in response to the approval request, and responsive to receiving the approval from the authorization layer, access the requested network resource.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example of a device suitable for accessing an unmatched network resource according to certain embodiments of this disclosure;

FIG. 2 illustrates an example of a server according to certain embodiments of this disclosure;

FIG. 3A illustrates an example of implementing a data clutch according to various embodiments of this disclosure;

FIG. 3B illustrates an example of implementing a data clutch in a network environment comprising a second trusted device, according to various embodiments of this disclosure;

FIGS. 4A-4D illustrate examples of network architectures for implementing a data clutch according to certain embodiments of this disclosure; and

FIG. 5 illustrates operations of an example method for implementing a data clutch according to certain embodiments of this disclosure.

### DETAILED DESCRIPTION

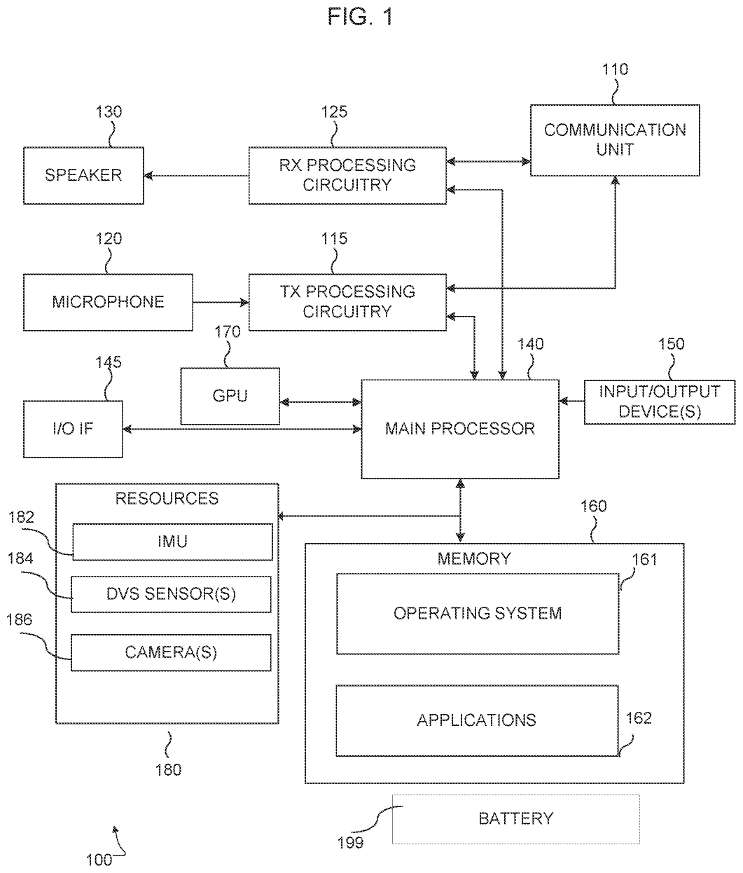

FIGS. 1 through 5, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged processing platform.

FIG. 1 illustrates a non-limiting example of a device 100 for accessing unfamiliar resources of an outside network according to some embodiments of this disclosure. According to various embodiments of this disclosure, device 100 could be implemented as one or more of a smartphone, a tablet, or a laptop computer. The embodiment of device 100 illustrated in FIG. 1 is for illustration only, and other configurations are possible. However, suitable devices come in a wide variety of configurations, and FIG. 1 does not limit the scope of this disclosure to any particular implementation of a device.

As shown in the non-limiting example of FIG. 1, the device 100 includes a communication unit 110 that may include, for example, a radio frequency (RF) transceiver, a BLUETOOTH transceiver, or a WI-FI transceiver, etc., transmit (TX) processing circuitry 115, a microphone 120, and receive (RX) processing circuitry 125. The device 100 also includes a speaker 130, a main processor 140, an input/output (I/O) interface (IF) 145, input/output device(s) 150, and a memory 160. The memory 160 includes an operating system (OS) program 161 and one or more applications 162.

Applications 162 can include web browsers, games, social media applications, applications for geotagging photographs and other items of digital content, virtual reality (VR) applications, augmented reality (AR) applications, operating systems, device security (e.g., anti-theft and device tracking) applications or any other applications which access resources of device 100 and can attempt to connect with machines on an outside network. According to some embodiments, the resources of device 100 include, without limitation, speaker 130, microphone 120, input/output devices 150, and additional resources 180.

The communication unit 110 may receive an incoming RF signal, for example, a near field communication signal such as a BLUETOOTH or WI-FI signal. The communication unit 110 can down-convert the incoming RF signal to generate an intermediate frequency (IF) or baseband signal. The IF or baseband signal is sent to the RX processing circuitry 125, which generates a processed baseband signal by filtering, decoding, or digitizing the baseband or IF signal. The RX processing circuitry 125 transmits the processed baseband signal to the speaker 130 (such as for voice data) or to the main processor 140 for further processing (such as for web browsing data, online gameplay data, notification data, or other message data). Additionally, communication unit 110 may contain a network interface, such as a network card, or a network interface implemented through software.

The TX processing circuitry 115 receives analog or digital voice data from the microphone 120 or other outgoing baseband data (such as web data, e-mail, or interactive video game data) from the main processor 140. The TX processing circuitry 115 encodes, multiplexes, or digitizes the outgoing baseband data to generate a processed baseband or IF signal. The communication unit 110 receives the outgoing processed baseband or IF signal from the TX processing circuitry 115 and up-converts the baseband or IF signal to an RF signal for transmission.

The main processor 140 can include one or more processors or other processing devices and execute the OS program 161 stored in the memory 160 in order to control the overall operation of the device 100. For example, the main processor 140 could control the reception of forward channel signals and the transmission of reverse channel signals by the communication unit 110, the RX processing circuitry 125, and the TX processing circuitry 115 in accordance with well-known principles. In some embodiments, the main processor 140 includes at least one microprocessor or microcontroller. According to certain embodiments, main processor 140 is a low-power processor, such as a processor which includes control logic for minimizing consumption of battery 199 or minimizing heat buildup in device 100.

The main processor 140 is also capable of executing other processes and programs resident in the memory 160. The main processor 140 can move data into or out of the memory 160 as required by an executing process. In some embodiments, the main processor 140 is configured to execute the applications 162 based on the OS program 161 or in response to inputs from a user or applications 162. Applications 162 can include applications specifically developed for the platform of device 100, or legacy applications developed for earlier platforms. The main processor 140 is also coupled to the I/O interface 145, which provides the device 100 with the ability to connect to other devices such as laptop computers and handheld computers. The I/O interface 145 is the communication path between these accessories and the main processor 140.

The main processor 140 is also coupled to the input/output device(s) 150. The operator of the device 100 can use the input/output device(s) 150 to enter data into the device 100. Input/output device(s) 150 can include keyboards, touch screens, mouse(s), track balls or other devices capable of acting as a user interface to allow a user to interact with device 100. In some embodiments, input/output device(s) 150 can include a touch panel, an augmented or virtual reality headset, a (digital) pen sensor, a key, or an ultrasonic input device.

Input/output device(s) 150 can include one or more screens, which can be a liquid crystal display, light-emitting diode (LED) display, an optical LED (OLED), an active matrix OLED (AMOLED), or other screens capable of rendering graphics.

The memory 160 is coupled to the main processor 140. According to certain embodiments, part of the memory 160 includes a random access memory (RAM), and another part of the memory 160 includes a Flash memory or other read-only memory (ROM). Although FIG. 1 illustrates one example of a device 100. Various changes can be made to FIG. 1.

For example, according to certain embodiments, device 100 can further include a separate graphics processing unit (GPU) 170.

According to certain embodiments, device 100 includes a variety of additional resources 180 which can, if permitted, be accessed by applications 162. According to certain embodiments, additional resources 180 include an accelerometer or inertial measurement unit (IMU) 182, which can detect movements of the electronic device along one or more degrees of freedom. Additional resources 180 include, in some embodiments, one or more dynamic vision sensors 184, and one or more cameras 186 (for example, complementary metal oxide semiconductor (CMOS) sensor type cameras) of device 100. According to various embodiments, DVS sensor(s) 184 comprises a pair of dynamic vision sensors spaced at a stereoscopically appropriate distance for estimating depth at over a field of depth of interest. According to some embodiments DVS sensor(s) 184 comprise a plurality of DVS sensors with overlapping, or partially overlapping fields of view.

According to various embodiments, the above-described components of device 100 are powered by battery 199 (for example, a rechargeable lithium-ion battery), whose size, charge capacity and load capacity are, in some embodiments, constrained by the form factor and user demands of the device. As a non-limiting example, in embodiments where device 100 is a smartphone, battery 199 is configured to fit within the housing of the smartphone and is configured not to support current loads (for example, by running a graphics processing unit at full power for sustained periods) causing heat buildup.

Although FIG. 1 illustrates one example of a device 100 for accessing unfamiliar resources of an outside network, various changes may be made to FIG. 1. For example, the device 100 could include any number of components in any suitable arrangement. In general, devices including computing and communication systems come in a wide variety of configurations, and FIG. 1 does not limit the scope of this disclosure to any particular configuration. While FIG. 1 illustrates one operating environment in which various features disclosed in this patent document can be used, these features could be used in any other suitable system.

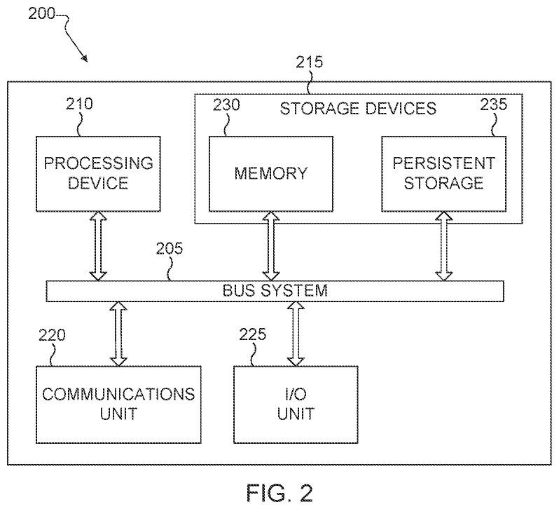

FIG. 2 illustrates an example of a server 200 that can be configured to act as a secure web gateway or secure access server according to certain embodiments of this disclosure. The embodiment of the server 200 shown in FIG. 2 is for illustration only and other embodiments could be used without departing from the scope of the present disclosure. According to certain embodiments, server 200 operates as a gateway for data passing between a device of a secure internal network (for example, device 100 in FIG. 1), and an unregulated external network, such as the internet.

In the example shown in FIG. 2, the server 200 includes a bus system 205, which supports communication between at least one processing device 210, at least one storage device 215, at least one communications unit 220, and at least one input/output (I/O) unit 225.

The processing device 210 executes instructions that may be loaded into a memory 230. The processing device 210 may include any suitable number(s) and type(s) of processors or other devices in any suitable arrangement. Example types of processing devices 210 include microprocessors, microcontrollers, digital signal processors, field programmable gate arrays, application specific integrated circuits, and discrete circuitry.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random-access memory or any other suitable volatile or non-volatile storage device(s). The persistent storage 235 may contain one or more components or devices supporting longer-term storage of data, such as a ready only memory, hard drive, Flash memory, or optical disc.

The communications unit 220 supports communications with other systems or devices. For example, the communications unit 220 could include a network interface card or a wireless transceiver facilitating communications over the network 102. The communications unit 220 may support communications through any suitable physical or wireless communication link(s).

The I/O unit 225 allows for input and output of data. For example, the I/O unit 225 may provide a connection for user input through a keyboard, mouse, keypad, touchscreen, or other suitable input device. The I/O unit 225 may also send output to a display, printer, or other suitable output device.

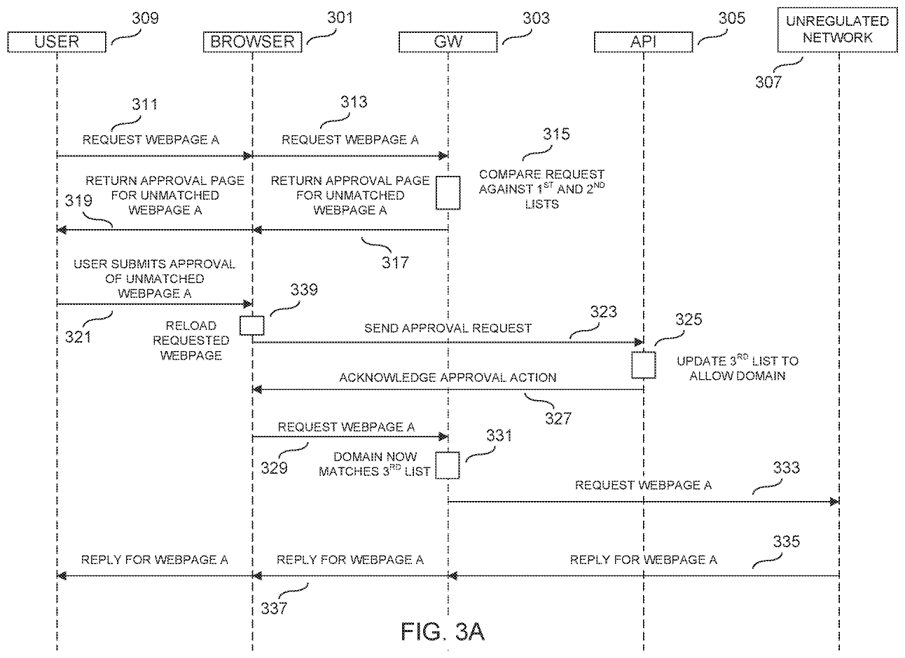

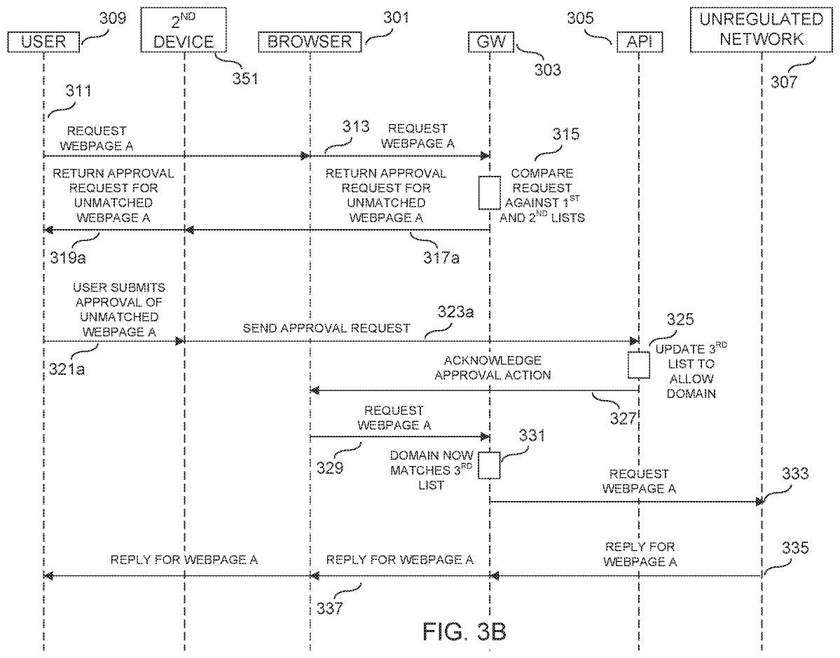

FIG. 3A illustrates an example of implementing a data clutch to actuate access to resources of an unmatched network location by a machine on a secure network, according to various embodiments of this disclosure.

Referring to the non-limiting example of FIG. 3A, the following four network actors are shown in this example—a browser 301, a secure web gateway 303, an authentication layer providing an application programming interface (API) 305, and an unregulated network 307 (for example, the internet). In this illustrative example, a user 309 is also shown as an actor in this sequence of operations.

According to various embodiments, browser 301 comprises an application running on a computing platform (for example, device 100 in FIG. 1) having access to, an internal network (for example, a company network), which is configured to access locations on one or more unregulated networks, including, without limitation, the World Wide Web. In this example, browser 301 receives as inputs, locations (for example, as specified by uniform resource locators (“URLs”) or internet protocol (IP) addresses) of resources (for example, web pages, or files for download) on one or more internal networks or on unregulated network 307.

In certain embodiments, secure web gateway 303 is communicatively connected to browser 301 and implements a gatekeeping functionality for data passing to and from browser 301 and unregulated network 307. In some embodiments, gateway 303 is embodied as an application executing on the same device as browser 301. In other embodiments, such as, for example, enterprise-scale networks, gateway 303 is embodied as an application or suite of applications executing on one or more gateway servers (for example, server 200 in FIG. 2). In some embodiments, gateway 303 is embodied as one or more applications executing on a cloud server. Further, in some embodiments, gateway 303 may be embodied on a cloud, or physical computing platform providing another network security functionality (for example, a virtual private network (VPN) server.

Referring to the non-limiting example of FIG. 3A, API 305 comprises an application processing interface communicatively connected to both browser 301 and gateway 303, through which both browser 301 and gateway 303 can interface with back-end processes of the data clutch process, as described herein. According to some embodiments, API 305 is embodied through one or more applications executing on the same device as browser 301. In certain embodiments, API 305 is embodied through one or more applications executing on a server (for example, server 200 in FIG. 2) which is a separate computing platform from the device providing browser 301. In certain embodiments, API 305 is embodied through one or more cloud-based applications. For example, in some embodiments, API 305 may be embodied at a cloud server or other networked computing platform providing another layer of network security, such as a VPN server.

Unregulated network 307 comprises a network of communicatively connected machines hosting resources which can be located by browser 301, at least certain of which are neither known to either gateway 303 or API 305 and operate outside of the control of a network administrator having access to gateway 303, API 305 and the device providing browser 301. The Internet, or World Wide Web is one non-limiting example of an unregulated network according to various embodiments of this disclosure. In the non-limiting example of FIG. 3A, a human user 309 is shown as viewing content through browser 301. Embodiments according to this disclosure are not so limited, and other architectures, in which a human or human-controlled process actuating a data clutch, may interact with a different application, which in turn, interacts with a browser, or otherwise presents requests for unmatched resources of an unregulated network.

Referring to the non-limiting example of FIG. 3A, at operation 311, a user requests a network resource, in this example, “Webpage A” associated with a particular URL through browser 301. In this example, the requested network resource is maintained on an unregulated network 307 on one or more machines outside of the control of an entity administering the machines providing browser 301, gateway 303, and API 305. According to various embodiments, at operation 313, the browser passes the request for the resource to gateway 303. At operation 315, the gateway performs a first comparison of an identifier of the requested network resource (for example, the domain name, URL or IP address) against a first list, wherein the first list comprises a list of identifiers of previously approved network resources (for example, approved web search pages, a company home page, etc.). According to various embodiments, at operation 315, the gateway performs a second comparison of the identifier of the requested network resource against a list of identifiers of previously prohibited network resources (for example, websites associated with malicious code or office-inappropriate content). According to certain embodiments, the gateway may also perform a third comparison of the identifier to the requested network against a third list, comprising identifiers of previously requested unmatched network resources. Responsive to the identifier being matched to an element of the first list (i.e., gateway 303 can confirm that the requested resource has been previously adjudged to be acceptable), gateway 303 passes the request to unregulated network 307. Similarly, responsive to the identifier being matched to an element of the second list (i.e., gateway 303 can confirm that the requested resource is unacceptable for viewing on devices of an administered network), gateway 303 blocks the request, and in some embodiments, returns a message to browser 301 that the request has been blocked.

However, skilled artisans will appreciate that the universe of bad actors and devices hosting harmful resources on unregulated, publicly accessible networks is a protean and, elusive target, with malicious actors readily being able to move harmful resources (for example, websites containing malware or other content which network administrators may wish to exclude) to locations associated with new identifiers. Thus, even with diligent updating and research, the contents of a “blocked” and “allowed” lists provide an imperfect and often out-of-date snapshot of the threat picture to a protected network, as many harmful network resources are unmatched resources. As used in this disclosure, the expression “unmatched resource” encompasses a resource of a network, for example, an unregulated network, such as unregulated network 307, having an identifier which does not yet match any items on lists of allowed, blocked, or otherwise categorized lists of network resources maintained by a security system (for example, gateway 303 and API 305) of an internal network.

Providing access to unmatched network resources presents a two-sided challenge with respect to balancing network administration issues and network security issues. On the one hand, for many enterprises, there is a significant cohort of users for whom it is unreasonable to limit their network access to just those network locations with identifiers on an allowed list. For many enterprises, the nature of their operations requires that at least some personnel (for example, journalists, certain law enforcement officers or other roles requiring research of other individuals' internet presence) be provided with broad access to unregulated networks, such as the internet. Thus, in many cases, it is not feasible for network administrators to limit access to unregulated networks to resources on an allowed list. At the same time, the universe of potential threats to an internal network can be large and rapidly evolving, meaning that a network security system focused only on excluding network resources matching to a blocked list is likely underinclusive and does to manage potential threat arising from unmatched network resources.

Certain embodiments according to the present disclosure provide a mechanism for managing access to unmatched resources in a way that balances providing a workable level of access for organizations that cannot limit their personnel's access to just an allowed list, while at the same time, provides heightened security over methods which only exclude resources matching a blocked list. Further, certain embodiments according to the present disclosure provide a mechanism for managing unmatched network resources which does not increase processing overhead at accessing devices (for example, the device providing browser 301), and at the same time, without imposing any new need upon network administrators to keep and update lists of categorized network resources.

Referring to the non-limiting example of FIG. 3A, where, at operation 315, gateway 303 determines that the requested network resource is neither on the first list or the second list (and where applicable, not on a third list of previously requested unmatched network resources), and is instead, a new unmatched network resource, gateway 303 initiates a data clutch process by which browser 301 can access the unmatched network resource. As used in this disclosure, the expression “data clutch” encompasses a digital analogy to the clutch of a manual transmission vehicle, where in contrast to an automatic transmission, actuating the transmission to change between gears has a manual, or user-provided component. In certain embodiments according to this disclosure, while portions of accessing an unmatched network resource proceed automatically, for the process to occur, similar to depressing the clutch of a manual transmission vehicle, the process of accessing an unmatched network resource also entails a user-actuated component.

Referring to the illustrative example of FIG. 3A, a data clutch process comprises gateway 303 sending, at operation 317 a request for manual authorization to be displayed by browser 301. According to certain embodiments, the request for manual authorization is provided as a page for display at the browser, the page comprising a confirmation of the unmatched network resource (for example, the domain name, URL or IP address of “Website A”) and a button or other object through which user 309 can, upon viewing the page at the browser, click on, or otherwise provide an input registering their authorization to access the unmatched network resource. According to various embodiments, at operation 319, the request for manual authorization (in this case, an approval page) is rendered for display to user 309 by browser 301.

While user 309 has the option of not actuating the data clutch process and denying the request to access the unmatched network presented by an approval page, in the non-limiting example of FIG. 3A, at operation 321, browser 301 receives authorization from the user to access the unmatched network resource.

As shown in the explanatory example of FIG. 3A, at operation 323, in response to receiving the user's authorization to access an unmatched network resource, browser 301 passes an approval request seeking approval to access the unmatched network resource to an authorization layer. In this non-limiting example, the authorization layer comprises API 305 and the backend systems maintaining one or more lists of identifiers of network resources and the user, group and global categorizations of the network resources (for example, categorizations of the network resources as allowed, blocked, or otherwise unmatched) for the internal network.

In various embodiments, at operation 325, in response to receiving the approval request from browser 301, the authorization layer or one or more APIs thereof (for example, API 305) interfaces with a backend management system to add an identifier of the unmatched network resource specified in the approval request passed at operation 323 to a list of unmatched network resources maintained at the authorization layer. According to various embodiments, at operation 325, the authorization layer may, in addition to adding an identifier of the unmatched network resource of the request, run or more scripts associated with the unmatched network resource, such as, logging the frequency of future visits to the unmatched network resource, or moving the identifier of the resource to another network administration list (for example, a blocked or allowed list) depending on the satisfaction of one or more predetermined conditions. Further, at operation 325, the authorization layer ratifies the user's approval of the request to access the unmatched network resource.

As shown in the illustrative example of FIG. 3A, at operation 327, the authorization layer passes the authorization layer's approval of the request to access the unmatched network resource. In some embodiments, the approval is provided as a flag (as used, for example, with the Chrome and Chromium browsers), switch or other command by which an outside application can programmatically trigger operations of browser 301.

According to certain embodiments, the data clutch process concludes with operation 327, and at operation 329, browser 301 once again requests the unmatched network resource, or in this particular example, “Website A” by passing the request to gateway 303. That is, the process of requesting the unmatched network resource of “Website A” picks back up from where it left off at operation 315, wherein, at operation 329, browser 301 passes the request for the same unmatched network resource to gateway 303. At operation 331, gateway 303 performs a comparison of an identifier of the network resource in the request of operation 329 against one or more lists of allowed, blocked or previously requested unmatched network resources.

However, due to the iteration of the data clutch process performed across operations 311 through 327, the requested network resource now belongs to a third list, or “greylist” of previously unmatched network resources, which through operation 325, has been mapped to a network security processes of the internal network. Accordingly, at operation 331, when gateway 303 performs a second comparison of an identifier of the requested network resource against one or more lists of allowed, blocked or unmatched network resources, the identifier of the requested network resource corresponds to an item of at least one list of unmatched network resources. Responsive to the requested network resource being found on at least one list of unmatched network resources, at operation 333 gateway 303 passes the request for the unmatched network resource to unregulated network 307.

Assuming that the unmatched still exists and receives the passed request, at operation 335, the unmatched network resource (in this case, “Website A”) returns, via unregulated network 307 a reply to the request to gateway 303. Depending on embodiments, gateway 303 may log, examine (for example, to check for malware or other unwanted content) the returned reply, or block (for example, if the reply does, in fact, contain malicious content) the reply from the unmatched network resource.

According to various embodiments, at operation 337, gateway 303 passes the reply from the unmatched network resource to browser 301 for display to user 309.

Implementing a data clutch process, such as described with reference to the non-limiting example of FIG. 3A, provides a number of technical and security benefits without imposing any meaningful processing loads at the networked machines hosting browsers (for example, browser 301). Specifically, certain embodiments according to this disclosure prevent malware from making automatic requests for access to unmatched network resources (a common mechanism for the propagation of spyware and malware) undetected, as new requests for access to unmatched network resources trigger the data clutch process. Further, by implementing a data clutch process, certain embodiments according to the present disclosure put unmatched network resources “on the radar” of network administrators, who can consult the “greylists” of unmatched network resources (for example, a list updated at operation 325) to provide a targeted, or specific change in network policy (as opposed to only limiting access to resources on an allowed list) when an unmatched network resource is discovered to be a source of malicious content. Still further, implementing a data clutch provides the technical and administrative benefit of not having to install, run and update a further layer of security software (for example, web filtering software) at the machine providing browser 301, as the comparison and authorizations of the data clutch process can be performed by one or more servers operating as a gateway and authorization layer, which work together to send (or not send) a flag to browsers operating on devices of the network. For most (if not all) browsers, the processing load associated with receiving and interpreting a flag from the authorization layer is minimal.

While the illustrative example of FIG. 3A has been described with reference to a process that begins with a new request for an unmatched network resource (for example, at operation 311) presented by a user to a browser, embodiments according to the present disclosure are not so limited, and the data clutch process can also be initiated by a browser (or other process of a machine on a managed or regulated network) attempting to reload or re-access a previously requested unmatched network resource. Referring to the non-limiting example of FIG. 3A, in some embodiments, an approval request is triggered at operation 339, wherein a user or process of the machine implementing browser 301 instructs browser 301 to reload a currently displayed webpage.

Additionally, while the non-limiting example of FIG. 3A has been described with reference to an architecture in which gateway 303 sends the request for approval (for example, at operation 317 in FIG. 3A) through browser 301, and user submits their approval through the browser (for example, at operation 321) the present disclosure is not so limited. In certain embodiments, the user's approval of the request to access the unmatched network resource can be mediated through any trusted device, not just a trusted device through which a user is attempting to access the unmatched network resource through browser 301. As an illustrative example, a user may attempt to access an unmatched network resource through a browser (for example, browser 301) executing on a first machine. However, instead of sending the request for approval back through the browser (for example, as in operation 317), the gateway may send the request for approval to a second, trusted device, such as a user's mobile phone.

FIG. 3B illustrates operations of a further example of implementing a data clutch in a network environment in which a user can provide inputs through two trusted devices. For convenience of cross-reference, elements of FIG. 3B which are common to FIG. 3A are numbered similarly.

Referring to the non-limiting example of FIG. 3B, in this example, an additional device, second trusted device 351 has been added to the network context previously shown in FIG. 3A. Thus, in the example of FIG. 3B, user 309 can interface with at least the following trusted electronic devices, a first device running the instance of browser 301, through which the request for access to an unmatched network resource is initially made at operation 313, and a second trusted device 351, which is communicatively connected to gateway 303 and the authorization layer providing API 305. According to some embodiments, the first device providing browser 301 and second trusted device 351 implement different or complementary user authentication mechanisms. For example, the first device may authenticate a user (or otherwise prevent unauthorized users from obtaining access) with a protected password, while second trusted device 351 authenticates a user based on a thumbprint or facial scanner. In this way, the overall security of the system and validity of approvals (for example, at operation 321 in FIG. 3A) may be enhanced.

As shown in the illustrative example of FIG. 3B, at operation 311, a user formulates a request for access to a resource maintained at a location on unregulated network 307 and presents the request through browser 301 executing on a first trusted device. In some embodiments, the user's request is presented as part of a web address, a uniform resource locator, or an IP address. According to various embodiments, the request for a network resource is passed from browser 301 to gateway 303 at operation 313.

In the explanatory example of FIG. 3B, as in the example of FIG. 3A, at operation 315, gateway 303 performs at least a first comparison of an identifier of the requested network resource against a first list of network resources, to determine if the identifier of the requested resource exists on at least one list of allowed network resources. In certain embodiments, the first comparison is performed against a set of hierarchically ordered lists defining the groups to which user 309 belongs (for example, a global list, a section list, and a list which is personal to user 309). Further, at operation 315, gateway 303 performs a second comparison of an identifier of the requested network resource against a second list of network resources to determine if the identifier of the requested resource exists on at least one list of blocked network resources. Again, in some embodiments, the identifier of the requested network resource may be compared against a plurality of hierarchically ordered lists defining the groups to which user 309 belongs. In some embodiments, at operation 315, a third comparison of the identifier of the requested network resource against one or more lists of previously identified unmatched network resources is performed.

Responsive to the comparisons of the identifier of the requested network at operation 315 not producing any matches of items on lists of network resources previously categorized as blocked, allowed, or unmatched, in the illustrative example of FIG. 3B, at operation 317a, an approval request is passed from gateway 303 to trusted second device 351, and presented to a user authenticated by second device 351 at operation 319a. According to some embodiments, the request is presented as a page viewable on a browser executing on second trusted device 351. In other embodiments, the approval request is presented through a separate application (for example, a security or authentication application, such as Duo Mobile) on second trusted device 351. According to various embodiments, upon receiving and viewing the approval request, user 309 has the option of approving or declining the request. Responsive to user 309 declining the approval request passed and presented at operations 317a and 319a, the process described with reference to FIG. 3B ends.

Responsive to a user indicating (for example, by pressing a button provided through a security application executing on second device 351) their approval of the request to access the requested network resource at operation 321a, at operation 323a, second trusted device 351 sends the approval request to the authentication layer providing API 305. Subsequently, operations 325-337 in FIG. 3B proceed as previously described with reference to FIG. 3A.

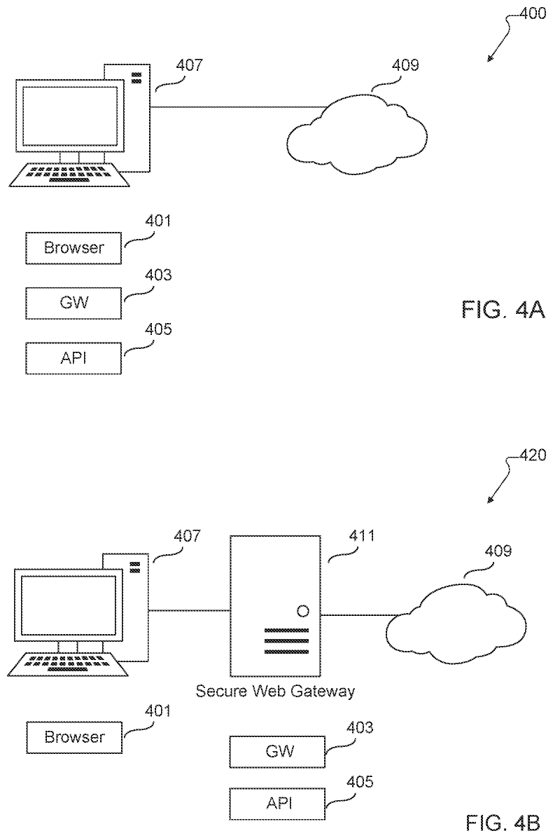

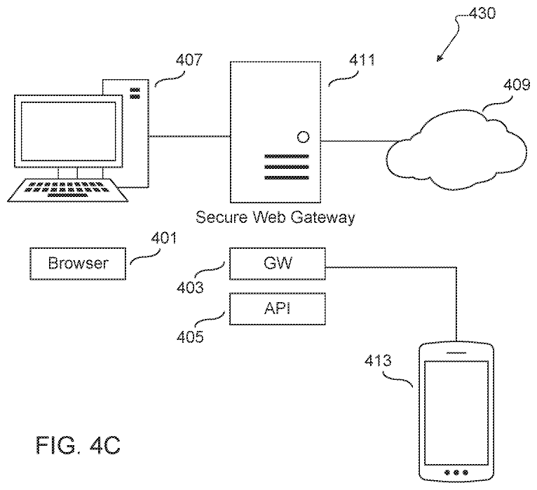

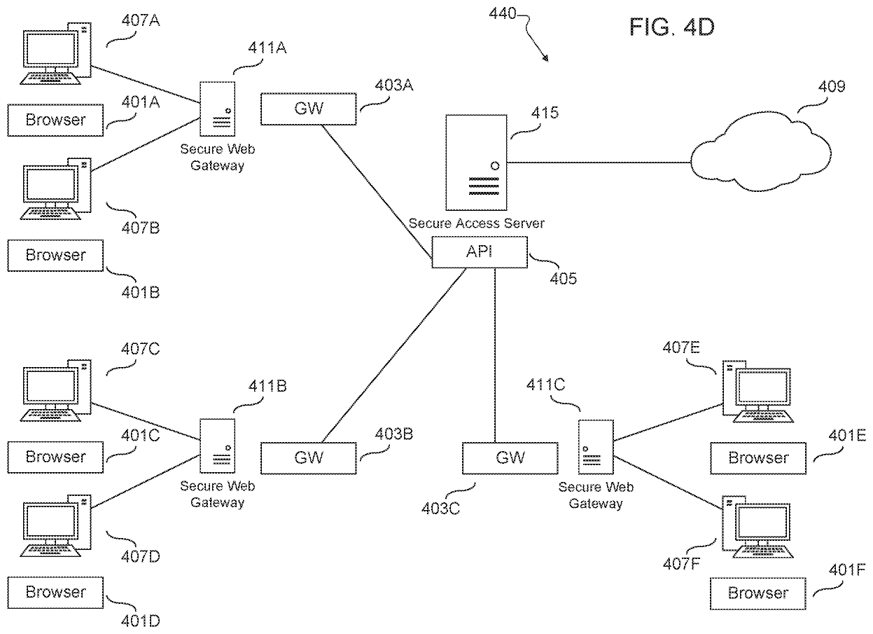

FIGS. 4A through 4D comprise a non-exhaustive set of examples of possible network architectures in which data clutch processes according to embodiments of this disclosure can be implemented. As shown with reference to the illustrative examples of FIGS. 4A-4D, embodiments according to the present application are extensible and flexible and can be implemented across a wide range of network architectures. For convenience of cross-reference, elements which are common to more than one of FIGS. 4A-4D are numbered similarly.

Referring to the non-limiting example of FIG. 4A, a first architecture 400 for implementing a data clutch process is shown in the figure. While a data clutch process can, in some embodiments, be implemented without executing any additional software at the device providing the browser (for example, browser 301 in FIG. 3A), embodiments according to the present disclosure are not so limited. As shown in the illustrative example of FIG. 4A, browser 401 (for example, an instance of browser 301 in FIG. 3A), gateway 403, and the API(s) 405 interfacing with an authentication layer, are all executing on a single machine 407, which is communicatively connected to unregulated network 409. According to certain embodiments, first architecture 400 may be a development architecture, such as used by a network administrator for configuring or testing an implementation of a data clutch process. According to other embodiments, first architecture 400 may be part of a backup or failsafe architecture, so that a data clutch process can still be implemented if a primary component (for example, a gateway server) of a multi-machine architecture goes down or is otherwise unavailable. Embodiments according to this disclosure include embodiments utilizing flexible architectures, in which the gateway and authorization layer functionalities can be moved across different machines, and as previously discussed, architectures in which user authentication is provided via a trusted machine other than the trusted machine hosting the browser through which an unmatched network resource is requested.

FIG. 4B illustrates an example of a second architecture 420 for implementing a data clutch according to various embodiments of this disclosure. In some embodiments, architecture 420 is implemented for an enterprise having an internal network of managed machines, which access outside, unregulated networks through a secure web gateway 411.

Referring to the non-limiting example of FIG. 4B, a first machine 407 of an internal, or managed network runs an instance of a browser 401, through which requests and responses for unmatched network resources, and requests for user authorization (for example, as in operation 317 in FIG. 3A) can be presented and received. In some embodiments, second architecture 420 is extensible, and first machine 407 is one of several machines running instances of browser 401.

As shown in FIG. 4B, first machine 407 is communicatively connected to a secure web gateway 411. According to some embodiments, secure web gateway 411 comprises one or more servers (for example, server 200 in FIG. 2) through which traffic between unregulated network 409 and machines of the internal, or managed network (for example, first machine 407) passes. As shown in the illustrative example of FIG. 4B, in second architecture 420, gateway 403 and authorization layer 405 are implemented as processes executing on secure web gateway 411.

FIG. 4C illustrates an example of a third architecture 430 for implementing a data clutch process according to various embodiments of this disclosure. Again, for convenience of cross-reference, the elements of third architecture 430, which have been previously described with respect to elements of other figures, are numbered similarly.

Referring to the non-limiting example of FIG. 4C, third architecture 430 builds upon second architecture 420 through the addition of a second trusted device 413 (for example, an instance of second trusted device 351 in FIG. 3B) communicatively connected to gateway 403 executing on secure web gateway 411. According to some embodiments, second trusted device 413 is a smartphone, tablet, or other device which has previously been associated with the registered user of browser 401. According to various embodiments, second trusted device 413 implements one or more security processes (for example, a password-based login, or facial recognition) by which only the authorized user of browser 401 can use second trusted device 413.

By establishing a communicative connection between second trusted device 413 and gateway 403, third architecture 430 facilitates sending a request for manual authorization (for example, as shown in operation 317a in FIG. 3B) to the trusted device, and receiving the user's manual authorization (for example, as shown in operation 321a in FIG. 3B) through the second trusted device. In this way, third architecture 430 leverages the security features (for example, password protection, or biometric authentication sensors) of the second trusted device to enhance the overall security of the data clutch process.

FIG. 4D illustrates an example of a fourth architecture 440 for implementing a data clutch process according to some embodiments of this disclosure. As shown by the non-limiting example of FIG. 4D, embodiments according to this disclosure are readily extensible, and the underlying processes can be scaled across multi-machine architectures. For convenience of cross-reference, elements shown in FIG. 4D that are common to, and described with reference to other figures of this disclosure are numbered similarly.

Referring to the non-limiting example of FIG. 4, a larger scale implementation of an architecture for providing a data clutch process is shown in the figure. As shown in this illustrative example, there are three clusters of user machines (designated 407A through 407E), wherein each cluster has one of three server machines (for example, gateway servers 411A through 411C) acting as a secure web gateway for each cluster of machines. As shown in the explanatory example of FIG. 4, the browser-gateway-authorization layer-unregulated network architecture has been extended to comprise three instances (for example, gateways 403A-403C) of the gateway process. Similarly, in the illustrative example of FIG. 4D, the suite of APIs 405 of the authorization layer are running on a standalone secure access server 415 (for example, a server such as described with reference to FIG. 2).

While examples of implementations of a data clutch process in networks embodying extended or varied architectures have been described herein with reference to embodiments in which operations of the data clutch process are distributed among different combinations of machines belonging to the internal or regulated network, the present disclosure is not so limited, and contemplates embodiments in which operations of either the gateway or authorization layer are performed by one or more cloud computing platforms connected via a secure communication link to the devices and browsers generating requests for unmatched network resources.

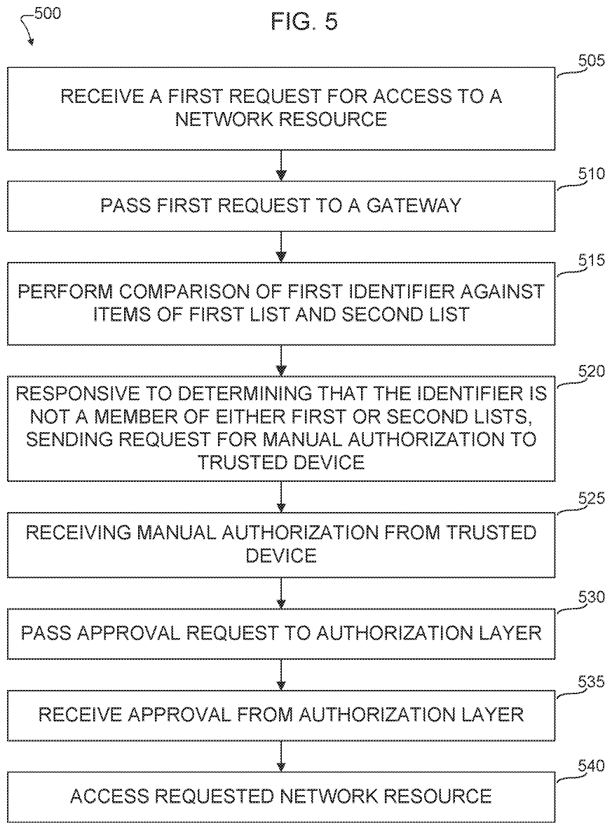

FIG. 5 illustrates operations of an example of a method for implementing a data clutch process according to various embodiments of this disclosure.

Referring to the non-limiting example of FIG. 5, at operation 505, a first device (for example, device 100 in FIG. 1), or process thereof (for example, browser 301 in FIG. 3A) receives a first request for access to a network resource (for example, a webpage, file transfer protocol site), wherein the first request comprises an identifier (for example, a domain name, URL, or IP address) of the requested resource. In some embodiments, the request at operation 505 is received as a user input (for example, entering a webpage address into a browser). In certain embodiments, the request at operation 505 is received programmatically, for example, by an application passing a flag to a browser executing on the machine.

According to various embodiments, at operation 510, the first request is passed to a gateway (for example, gateway 303 in FIG. 3A, or gateway 403C in FIG. 4D). In some embodiments (for example, in first architecture 400 in FIG. 4A), passing the first request comprises a call from one application executing on a machine to another application executing on the same machine. In certain embodiments, passing the first request at operation 510 comprises sending the first request, including the identifier, to another machine (for example, secure web gateway 411 in FIG. 4B).

As shown in the explanatory example of FIG. 5, at operation 515, the gateway performs a comparison (for example, the comparison shown at operation 315 in FIG. 3A) of the first identifier against a first list, comprising identifiers of “allowed” or approved network resources, and a comparison of the first identifier against a second list, comprising identifiers of “blocked” or prohibited network resources. Further, in certain embodiments, the gateway also compares the first identifier against a third list of identifiers of previously requested unmatched network resources (for example, as described with reference to operation 331 in FIG. 3A). Depending on embodiments and configurations, operation 515 may be iterated across a hierarchical set of first and second lists, comprising top level lists specifying “allowed” and “blocked” network resources applicable to all network users, intermediate level lists specifying network resources that may be allowed or blocked for a particular group or tier of users, and then a bottom-level list of sites which are specifically allowed or blocked for a particular user.

Referring to the illustrative example of FIG. 5, at operation 520, responsive to determining that the first identifier does not match any members of a first list of allowed network resources, nor does it match any members of a second list of blocked network resources, the gateway initiates a data clutch process according to certain embodiments of this disclosure, by which a user is made aware of the unmatched status of the requested network resources, and in some embodiments, the unmatched network resource is mapped to the security procedures of the network. According to various embodiments, at operation 520, the gateway initiates the data clutch process by sending, to a trusted device associated with the user of the machine submitting the first request, a request for manual authorization to access the unmatched network resource. According to some embodiments, the trusted device is the device from which the first request was passed at operation 510 to the gateway. In some embodiments, the trusted device is a second device (for example, a user's smartphone or smartwatch) with separate or complementary (for example, if the first trusted device uses password protection, and the second trusted device uses a fingerprint scanner) user authentication to the first device.

As shown in the illustrative example of FIG. 5, at operation 525, manual authorization to access the unmatched network resource is received from the trusted device. In some embodiments, at operation 525, a user registers their authorization to access the unmatched network resource through the browser (for example, browser 301 in FIG. 3A) through which they initially requested access to the resources. In various embodiments, at operation 525, manual authorization is received as an input (for example, a touch on a touchscreen) at a separate authorization application presented on the trusted device.

According to various embodiments, at operation 530, the manual authorization from the trusted device is passed to an authorization layer. According to certain embodiments, the authorization layer comprises one or more application programming interfaces for mediating the exchange of data between various actors of the internal network, such as browsers on networked devices, trusted external devices used for authentication (for example, trusted device 413 in FIG. 4C), one or more gateways, and a back-end functionality embodying decision logic for permitting or denying requests for accessing network resources, and also maintaining lists of unmatched network resources. According to some embodiments, the authorization layer further comprises control logic for triggering one or more scripts (for example, a script logging subsequent accesses to a particular network resource) associated with managing access to unmatched network resources.

Referring to the non-limiting example of FIG. 5, at operation 535, responsive to the approval request being received and approved at the authorization layer, the device or application through which access to the unmatched network resource is requested (for example, browser 301 in FIG. 3A) receives approval from the authorization layer. In certain embodiments, the approval is provided as a flag or command to the requesting process to re-attempt the request for access to the network resource. In this way, certain embodiments according to the present disclosure are able to manage access to unmatched network resources without requiring the accessing devices to run additional applications or software. Thus, certain embodiments according to this disclosure enhance security without concomitant increases in processing loads at end-user machines.

Referring to the non-limiting example of FIG. 5, at operation 540, the device or application presenting the first request, accesses the requested network resource (for example, as shown in operations 333-337 of FIG. 3A.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A method comprising:
at a first electronic device comprising a processor and connected to a network, receiving at a browser, a first request for access to a network resource, wherein the first request comprises a first identifier of a location on the network;
passing the first request from the browser to a gateway;
performing, by the gateway, a comparison of the first identifier against items of a first list and items of a second list;
responsive to determining, based on the comparison, that the first identifier is not an item of the first list or an item of the second list, initiating, by the gateway, a data clutch process,
wherein the data clutch process comprises:
sending from the gateway to a trusted device, a request for manual authorization;
receiving manual authorization at the trusted device;
responsive to notification of the manual authorization, passing an approval request to an authorization layer; and
receiving, by the browser, an approval from the authorization layer in response to the approval request; and
responsive to receiving the approval from the authorization layer, accessing the requested network resource.

2. The method of claim 1, wherein the trusted device is the first electronic device.

3. The method of claim 1, wherein the trusted device is a second electronic device.

4. The method of claim 1, wherein accessing the requested network resource comprises loading a webpage at the browser.

5. The method of claim 1, wherein the browser and the gateway comprise applications executed by the processor at the first electronic device.

6. The method of claim 1, wherein the authorization layer comprises an application programming interface between the first electronic device and an application executed at a second electronic device.

7. The method of claim 1, wherein the gateway comprises an application executing at a second electronic device.

8. The method of claim 1, wherein performing the data clutch process further comprises adding the first identifier to a third list, the third list comprising unmatched identifiers.

9. The method of claim 8, further comprising:
performing by the gateway, a comparison of the first identifier against items of the third list; and
responsive to determining that the first identifier is an item of the third list, accessing the requested network resource.

10. An apparatus comprising:
a network interface connected to a network;
a processor; and
a memory containing instructions, that when executed by the processor, cause the apparatus to:
receive at a browser executing on the apparatus, a first request for access to a network resource, wherein the first request comprises a first identifier of a location on the network,
pass the first request from the browser to a gateway for comparison of the first identifier against items of a first list and items of a second list,
responsive to a determination by the gateway that the identifier is not an item of the first list or an item of the second list, receive, from the gateway a request for manual authorization to be displayed by the browser,
obtain notification of manual authorization at a trusted device,
responsive to receiving notification of the manual authorization, pass an approval request to an authorization layer,
receive, by the browser, an approval from the authorization layer in response to the approval request, and
responsive to receiving the approval from the authorization layer, access the requested network resource.

11. The apparatus of claim 10, wherein the trusted device is also the apparatus.

12. The apparatus of claim 10, wherein the trusted device is a separate electronic device.

13. The apparatus of claim 10, wherein accessing the requested network resource comprises loading a webpage at the browser.

14. The apparatus of claim 10, wherein the browser and the gateway comprise applications executed by the processor at the apparatus.

15. The apparatus of claim 10, wherein the authorization layer comprises an application programming interface between the apparatus and an application executed at a second electronic device.

16. The apparatus of claim 10, wherein the gateway comprises an application executing at a second electronic device.

17. The apparatus of claim 10, wherein the authorization layer adds the first identifier to a third list, the third list comprising unmatched identifiers.

18. The apparatus of claim 17, wherein the gateway performs a comparison of the first identifier against items of the third list and responsive to determining that the first identifier is an item of the third list, allows the apparatus to access the requested network resource.

19. A non-transitory, computer-readable medium containing program code, that, when executed by a processor, causes an apparatus to:
receive at a browser executing on the apparatus, a first request for access to a network resource, wherein the first request comprises a first identifier of a location on the network,
pass the first request from the browser to a gateway for comparison of the first identifier against items of a first list and items of a second list,
responsive to a determination by the gateway that the identifier is not an item of the first list or an item of the second list, receive, from the gateway a request for manual authorization to be displayed by the browser,
obtain notification of manual authorization at a trusted device,
responsive to receiving notification of the manual authorization, pass an approval request to an authorization layer,
receive, by the browser, an approval from the authorization layer in response to the approval request, and
responsive to receiving the approval from the authorization layer, access the requested network resource.

20. The non-transitory, computer readable medium of claim 19, wherein the trusted device is also the apparatus.
